(19) United States
(12) Patent Application Publication
(10) Pub. No.: US 2006/0028938 A1
(43) Pub. Date: Feb. 9, 2006

(54) Method of formatting recording medium, host apparatus, and recording and/or reproducing apparatus

(75) Inventors: Sung-hee Hwang, Seoul (KR); Sang-hyun Ryu, Suwon-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/087,567

(22) Filed: Mar. 24, 2005

(30) Foreign Application Priority Data
Jul. 19, 2004 (KR) 2004-55895

(51) Int. Cl. G11B 19/02

(52) U.S. Cl. 369/47.1

(57) ABSTRACT

A method of formatting a recording medium, and a host apparatus and/or recording and/or reproducing apparatus which use the method. The method includes providing information regarding a size and/or location of a user data area actually allocated on the recording medium after allocation of the user data area in a data area on the recording medium to format the recording medium.

### CROSS-REFERENCE TO RELATED APPLICATIONS

This application claims the benefit of Korean Patent Application No. 10-2004-55895, filed on Jul. 19, 2004, in the Korean Intellectual Property Office, the disclosure of which is incorporated herein by reference.

### BACKGROUND OF THE INVENTION

1. Field of the Invention

The present invention relates to a recording medium such as a disc, and, more particularly, to a method of formatting a recording medium, a host apparatus, and a recording and/or reproducing apparatus.

2. Description of the Related Art

Generally, in a rewritable information storage medium, a spare area is disposed in a part of a data area in order to manage defects. That is, while user data is recorded in a user data area, which is an area excluding the spare area in the data area, or while data recorded in the user data area is reproduced, if a defect is found, replacement data used to replace the defective data is recorded in the spare area. This spare area should be allocated when the rewritable information storage medium is initialized or re-initialized.

Also, this defect management method is used for logical overwrite (LOW) on a write once information storage medium. LOW is a method similar to data rewriting. That is, in order to update data already recorded in a user data area, the recorded data is treated as if the data is defective data, and data to replace the recorded data is recorded in a spare area.

By doing so, while the logical address of the data recorded in the user data area is fixed, the address of data recorded in the spare area is used as a physical address corresponding to the logical address. Accordingly, a host sees the update as if rewriting is performed at the identical address of the data in the user data area, and therefore management becomes easier. This is because the host controls only the logical address. Accordingly, in the write once information storage medium, as in the rewritable information storage medium, the spare area should be allocated when the medium is initialized.

A formatting process, including allocation of a spare area in a write once recording medium or a rewritable medium according to the conventional technology, will now be explained. The formatting process includes allocation of a user data area and/or a spare area on a recording medium when the medium is initialized or re-initialized, and may further include recording initial information in the thus allocated area.

FIG. 1 is a flowchart of a process of formatting a write once recording medium or a rewritable medium according to the conventional technology.

First, a host 1 requests information from a drive system regarding the size of a data area and the maximum size of a spare area that can be allocated on the information storage medium in operation 101.

The drive system 2 receives the request from the host 1 and reports the information regarding the size of the data area and the maximum size of the spare area that can be allocated on the information storage medium to the host 1 in operation 102.

The host 1 receives the report and determines the size of the user data area and the size of the spare area to be allocated based on the size of the data area on the information storage medium and the possible size of the spare area that can be allocated by the drive system 2, and commands the drive system 2 to allocate the spare area in operation 103.

The drive system 2 receives the formatting command, including allocation of the spare area, from the host 1 and allocates the spare area according to a predetermined rule, and records the location or size information of the spare area, and the location or size information of the user data area according to the allocation of the spare area, in a predetermined area on the information storage medium in operation 104.

Next, the host 1 sends a command to the drive system 2 to record an initial file system in the user data area on the information storage medium in operation 105.

The drive system 2 receives the file system recording command from the host 1 and records the file system in the start address or end address of the user data area on the information storage medium in operation 106.

The size of the user data area that the host determines according to the above formatting process can be different from the actual size of the user data area on the information storage medium. This is attributed to two reasons.

One reason is that the host processes data in units of sectors (2048 bytes), and the drive system processes data in units of blocks (16 sectors or 32 sectors). Accordingly, when the host commands allocation of the user data area and the spare area at the beginning, it cannot be guaranteed that the sizes thereof are multiples of the blocks processed in the drive system, and therefore the size of the user data that the host determines when it sends a command to format the information storage medium can be different from the actual size of the user data area on the disc after formatting.

The second reason is that a standard for the drive system uses a predetermined allocation rule when a spare area is allocated, and the drive system allocates a spare area complying with the rule. At this time, since the size of the allocated spare area requested at first by the host can be different from the size of the spare area allocated by the drive system according to the predetermined rule of the standard, the size of the user data area determined by the host before the allocation of the spare area can be different from the actual size of the user data area allocated on the disc after the spare area is allocated.

If, after such formatting is performed, the host commands recording without checking the size of the actual user data area allocated by the drive system according to the standard, the following problem can be caused.

Generally, in the case of a rewritable information storage medium, file system data is recorded at the front and end of a user data area. This also applies to a write once information storage medium implementing LOW. If the end address of the user data area that the host has determined is different from the end address of the actual user data area on the disc determined to comply with the standard, when the host records the file system as described above, and the medium is later loaded again on the drive system, the host will confirm the size and the start and end location information of the user data area of the disc to the drive system and reproduce information of the file system. However, since the actual location of the file system recorded on the medium can be different from the location of the file system expected by the host based on the size and location information of the user data area on the medium, the host cannot reproduce the file system recorded on the medium because the data recorded on the medium cannot be correctly reproduced.

This problem will now be explained through a specific example with reference to FIG. 2.

FIGS. 2A-2C are reference diagrams illustrating allocation of a user data area and a spare area on a medium in a formatting process according to the conventional technology.

FIG. 2 A shows a state of a recording medium, in this case a disc, which is not formatted, FIG. 2 B shows a state of a recording medium on which a spare area is allocated by a command from a host, and FIG. 2 C shows a state of a recording medium on which a file system is recorded in a user data area according to the command from the host.

Referring to FIG. 2 A, the disc that is not formatted has a lead-in area 210, a data area 220, and a lead-out area 230. It is assumed that size of the data area 220 is 20000h blocks. Assuming that 1 block is 32 sectors (32*2048 bytes), the size of the data area corresponds to 400000h sectors in hexadecimals. It is assumed that the size of a spare area permitted by the drive system is a minimum of 400h blocks, and a maximum of 1000h blocks, and a standard for the drive system or the disc fixes the size of the “inner spare area” as 400h blocks, and forces the size of the “outer spare area” to be a multiple of a predetermined block size (N=80h).

According to the request of the host, as in operation 101 of FIG. 1, the drive system reports to the host that “the size of the data area=400000h sectors (20000h blocks*20h sectors) and the maximum size of the spare area that can be allocated=20000h sectors (1000h blocks*20h sectors).” The drive system processes the size of data in units of blocks, but the host processes the size of data in units of sectors. Assuming that 1 block is 32 sectors, and since 32 is 20h in the hexadecimal notation, 1 block is therefore 20h sectors.

It is assumed that, after receiving this report from the drive system, the host commands the drive system to allocate “the size of the user data=3E8850h sectors and the size of the spare area to be allocated=177B0h”. Since the host accesses data in units of sectors, this is a valid command that may be sent by the host.

Then, the user data size 3E8850h sectors are rounded up to 3E8860h to become block data (since the drive system accesses in units of blocks), and the spare area is recalculated as 177A0h. According to the standard, the drive system first allocates 8000h sectors (400h blocks) to the inner spare area 221, and, for the outer spare area 223, performs the calculation again, for the F7A0h sectors (177A0h-8000h) that remain after allocation of the inner spare area 221, with a multiple of a predetermined block size (N=80h). Also, according to the standard, the maximum sectors that can be allocated to the outer spare area 223 are F780h (since it should be a multiple of 80h). Accordingly, the size of the user data area 222 actually allocated on the medium by the drive system is 3E8880h sectors (400000h-17780h). Then, the drive system records the size information (8000h sectors and F780h sectors) of the allocated inner and outer spare areas, and the resulting actual size information (3E8880h sectors) of the user data area, on the recording medium as disc management information.

However, since the host is still only aware of the size of the user data area and the size of the spare area according to the command which it sent to the drive system, assuming that the drive system performs allocation of the size of the user data area per the command from the host, the host will send a write command of a file system (FS) data based on the user data size of 3E8850h sectors. The file system data is recorded in the start address or the end address of the user data area, and, for example, if it is recorded at the end address, since the size of the user data area actually allocated is different from the size of the user data area that the host determined, the difference Δ as shown in FIG. 2 C can occur. Accordingly, the file system is recorded at the address B, the address based on the user data size of 3E8850h sectors according to the intention of the host, and, after that time, even when the host reproduces the file system recorded in the user data area, the drive system reports the actual size information (3E8880h sectors) of the user data area, recorded as disc management information, to the host. Accordingly, the host transmits a command to the drive system to reproduce a file system in address A (the address based on the actual user data size of 3E8880h sectors) according to the reported information. Since the drive system reads data recorded in address A and sends the data to the host, the host cannot obtain the actual file system information, and the file system read operation fails. Since the file system cannot be obtained, data recorded on the recording medium cannot be reproduced. Meanwhile, though the case in which the size of the inner spare area is fixed is explained above as an example, the same problem can also occur in the start address of a user data area in a case in which the size of the inner spare area is not fixed.

### SUMMARY OF THE INVENTION

The present invention provides a method of formatting a recording medium, a host apparatus, and a recording and/or reproducing apparatus by which, when formatting is performed, file system information is made to be recorded in an actually allocated user data area such that reproduction errors can be reduced.

Additional aspects and/or advantages of the invention will be set forth in part in the description which follows and, in part, will be obvious from the description, or may be learned by practice of the invention.

According to an aspect of the present invention, there is provided a host apparatus to format a recording medium, the apparatus including: a control unit to request a recording and/or reproducing apparatus which allocates a spare area in a data area on the recording medium to format the recording medium, and to request information regarding a size and/or location of a user data area actually allocated on the recording medium in order to determine the size and/or location of the actually allocated user data area.

The control unit may further transmit a file system write command to the recording and/or reproducing apparatus based on the information regarding the size and/or location of the actually allocated user data area.

According to another aspect of the present invention, there is provided a recording and/or reproducing apparatus to format a recording medium, the apparatus including: a writing/reading unit to record data on or read data from the recording medium; and a control unit to control the writing/reading unit, to allocate a spare area in a data area on the recording medium to format the recording medium, and to porovide information regarding a size and/or location of a user data area actually allocated on the recording medium, to a host apparatus.

The control unit may control the writing/reading unit such that a file system write command based on the information regarding the size and/or location of the actually allocated user data area is received from the host apparatus and file system data is recorded in the actually allocated user data area of the recording medium.

According to still another aspect of the present invention, there is provided a method of formatting a recording medium, the method including: requesting information, from a recording and/or reproducing apparatus which allocates a spare area in a data area on the recording medium to format the recording medium, regarding a size and/or location of a user data area actually allocated on the recording medium; and determining the size and/or location of the user data area of the recording medium according to the information regarding the size and/or location of the actually allocated user data area received from the recording and/or reproducing apparatus.

The method may further include transmitting a file system write command to the recording and/or reproducing apparatus based on the information regarding the size and/or location of the actually allocated user data area.

According to yet still another aspect of the present invention, there is provided a method of formatting a recording medium, the method including: allocating a spare area in a data area on the recording medium to format the recording medium; and providing information regarding a size and/or location of a user data area actually allocated on the recording medium to a host apparatus.

The method may further include receiving, from the host apparatus, a file system write command based on the information regarding the size and/or location of the actually allocated user data area, and recording file system data in the actually allocated user data area of the recording medium.

According to a further aspect of the present invention, there is provided a method of formatting a recording medium, the method including: controlling a recording and/or reproducing apparatus such that a spare area is allocated in a data area on the recording medium to format the recording medium; requesting information from the recording and/or reproducing apparatus regarding a size and/or location of a user data area actually allocated on the recording medium; determining the size and/or location of the actually allocated user data area of the recording medium according to the information regarding the size and/or location of the actually allocated user data area received from the recording and/or reproducing apparatus; and controlling the recording and/or reproducing apparatus such that file system information is recorded based on the determined size and/or location of the actually allocated user data area.

According to an additional aspect of the present invention, there is provided a method of formatting a recording medium, the method including: allocating a spare area in a data area on the recording medium to format the recording medium; receiving a request from a host apparatus for information regarding a size and/or location of a user data area actually allocated on the recording medium; providing the information regarding the size and/or location of the user data area actually allocated on the recording medium to the host apparatus; and recording file system information in the actually allocated user data area according to a file system write command transmitted by the host apparatus based on the size and/or location of the actually allocated user data area.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a process of formatting a write once recording medium or a rewritable medium according to the conventional technology;

FIGS. 2A-2C are reference diagrams illustrating allocation of a user data area and a spare area on a medium in a formatting process according to the conventional technology;

FIG. 3 is a schematic block diagram of the structure of a recording and/or reproducing apparatus according to an embodiment of the present invention;

FIG. 4 is a detailed block diagram of the structure of the recording and/or reproducing apparatus shown in FIG. 3;

FIG. 5 is a reference diagram illustrating a disc area to which the present invention is applied;

FIG. 6 is a flowchart of a process of formatting a write once recording medium or rewritable medium according to an embodiment of the present invention; and

FIGS. 7A-7C are reference diagrams illustrating allocation of a user data area and a spare area on a medium in a formatting process according to an embodiment of the present invention.

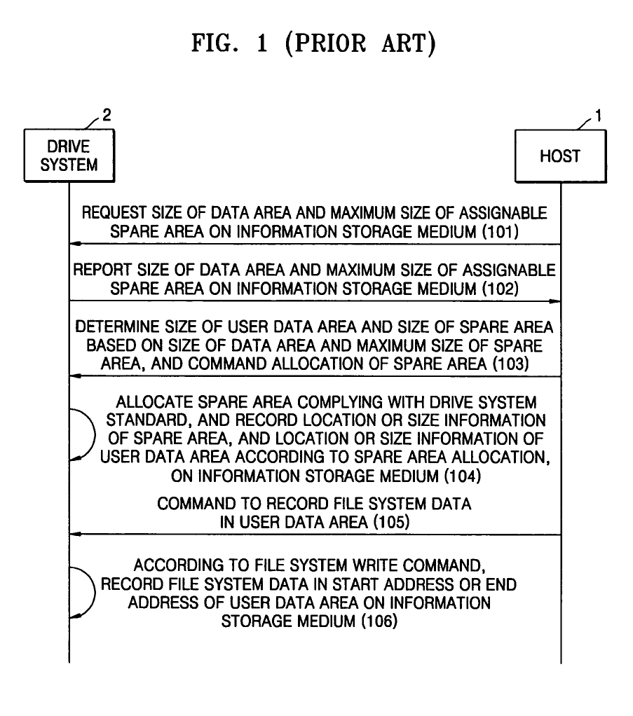

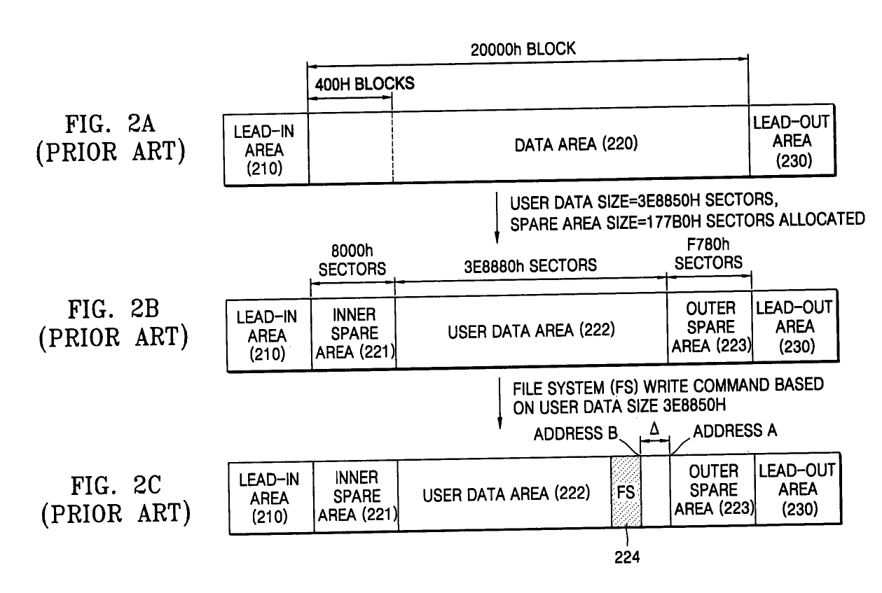

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

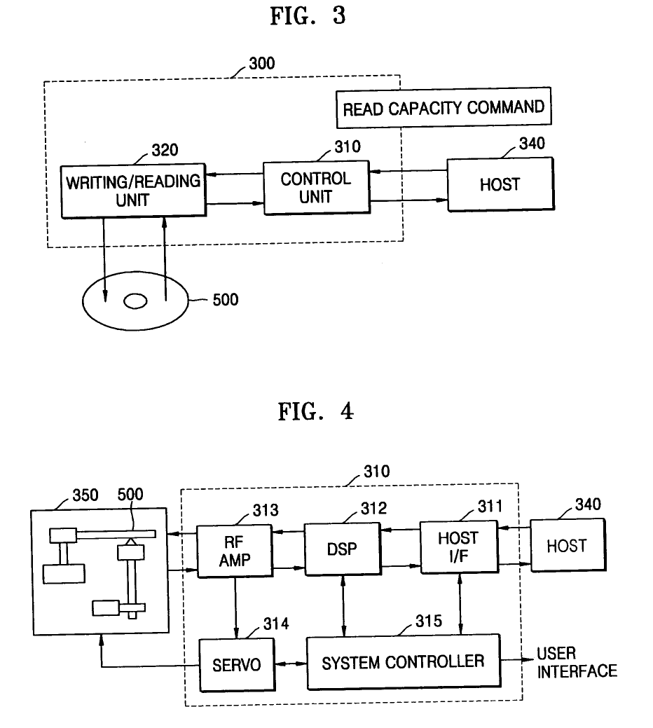

Referring to FIG. 3, a recording and/or reproducing apparatus having a drive system 300 according to an embodiment of the present invention is an apparatus capable of recording and/or reproducing data, and includes a writing/reading unit 320 and a control unit 310. According to a control of the control unit 310, the writing/reading unit 320 records data on an information storage medium, which is a disc 500 according to the present embodiment, and/or reads data from the disc 500 to reproduce the recorded data. The control unit 310 controls the writing/reading unit 320 so that data is recorded or read, and processes data read by the writing/reading unit 320 to obtain valid data. In particular, when the disc 500 is formatted according to an embodiment of the present invention, the control unit 310 receives a command to allocate a spare area from a host 340, and allocates the spare area and the user data area. Then, if a “read capacity command” requesting the size of the user data area actually allocated on the disc 500 is received, the control unit 310 reports information regarding the size of the actually allocated user data area to the host 340. By doing so, the host 340 can determine the size and/or location of the actually allocated user data area such that, by using the size and/or location information, the host 340 can issue a command to record a file system accurately in the start address or end address of the actually allocated user data area. Accordingly, after that time, file system reproduction errors can be prevented, and therefore data reproduction errors can also be prevented.

FIG. 4 is a detailed block diagram of the structure of the recording and/or reproducing apparatus shown in FIG. 3.

Referring to FIG. 4, the drive system 300 has a pickup 350 as the writing/reading unit 320. The disc 500 is placed on the pickup 350. Also, the drive system 300 includes a host I/F 311, a DSP 311, an RF AMP 313, a servo 314, and a system controller 315 as the control unit 310.

When the disc 500 is formatted, the host 340 requests information regarding the size of the data area and the maximum size of a spare area that can be allocated on the disc 500, receives a response to the request from the control unit 310 of the drive system 300, determines the size of the user data area and the size of the spare area by referring to the information regarding the size of the data area and the size of the spare area that can be allocated on the disc 500, and sends a command to the drive system 300 to allocate the spare area. Also, after the drive system 300 allocates the user data area and the spare area on the disc 500 by referring to its standard, the host 340 sends a ‘read capacity command’ to request the size of the user data area actually allocated on the disc 500, and if the drive system 300 reports information regarding the size of the user data area actually allocated on the medium, sends a command to the drive system 300 to record a file system based on the information regarding the actual size of the user data area.

The host I/F 311 receives the command from the host 340, transmits the command to the system controller 315, and sends the report from the system controller 315 to the host 340.

If a command is received from the host 340 requesting information regarding the size of the data area and the maximum size of a spare area that can be allocated on the disc 500, the system controller 315 provides related information as a response to the host 340. And if a command from the host 340 is received to allocate a spare area on the disc 500, the system controller 315 controls the servo 314 and the DSP 312 according to the command such that by referring to the standard of the drive system 300 itself, and based on the information regarding the size of the user data area and the size of the spare area according to the command from the host, the user data area and the spare area are allocated and information regarding the size and/or location of this actually allocated user data area and the size and/or location of the spare area is recorded in the disc management area disposed in the lead-in area of the disc 500.

Also, the system controller 315 receives the “read capacity command” from the host 340, reports information regarding the size of the user data area actually allocated on the disc 500, and if a file system write command based on the size of the actually allocated user data area from the host 340 is again received, controls the servo 314 and the DSP 312 such that the file system data is recorded in the start address or end address of the actually allocated user data area.

After the formatting, when data is recorded on the disc 500, or when data recorded on the disc 500 is reproduced, the host I/F 311 first receives a request for information regarding the size of the user data area from the host 340. The system controller 315 reads information regarding the size and/or location of the user data area and the size and/or location of the spare area recorded in the disc management area of the lead-in area of the disc 500, and provides the information to the host 340. If, based on this information, the host 340 transmits a command to the drive system 300 to fetch the file system data from the location, the system controller 315 reads the file system data in the start address or end address of the user data area, and provides the data to the host 340. Based on the thus obtained file system information, the host 340 can send a command to the drive system 300 to record data in the user data area or to reproduce data recorded in the user data area.

When data is recorded, the host I/F 311 receives a command from the host 340, transmits the command to the system controller 315, and transmits the data to be recorded to the DSP 312. For error correction, the DSP 312 adds additional data, such as a parity, to the data received from the host I/F 311 and to be recorded, performs error correction code (ECC) encoding to generate an ECC block that is an error correction block, and then modulates the generated ECC block in a predetermined method. The RF AMP 313 converts the data output from the DSP 312 into an RF signal. The pickup 350 records the RF signal output from the RF AMP on the disc 500. The servo 314 receives a command input required for servo control from the system controller 315, and servo controls the pickup 350.

When data is reproduced, the pickup 350 irradiates a laser beam on the disc 500, and outputs an optical signal obtained by receiving the laser beam reflected from the disc 500. The RF AMP 313 converts the optical signal output from the pickup 350 into an RF signal, and provides modulated data obtained from the RF signal to the DSP 312, while providing a servo signal for control, obtained from the RF signal, to the servo 314. The DSP 312 demodulates the modulated data and outputs data obtained through ECC error correction. Meanwhile, the servo 314 receives a servo signal from the RF AMP 313, and a command required for servo control received from the system controller 315, and performs servo control of the pickup 350. The host I/F 311 transmits the data received from the DSP 312 to the host 340.

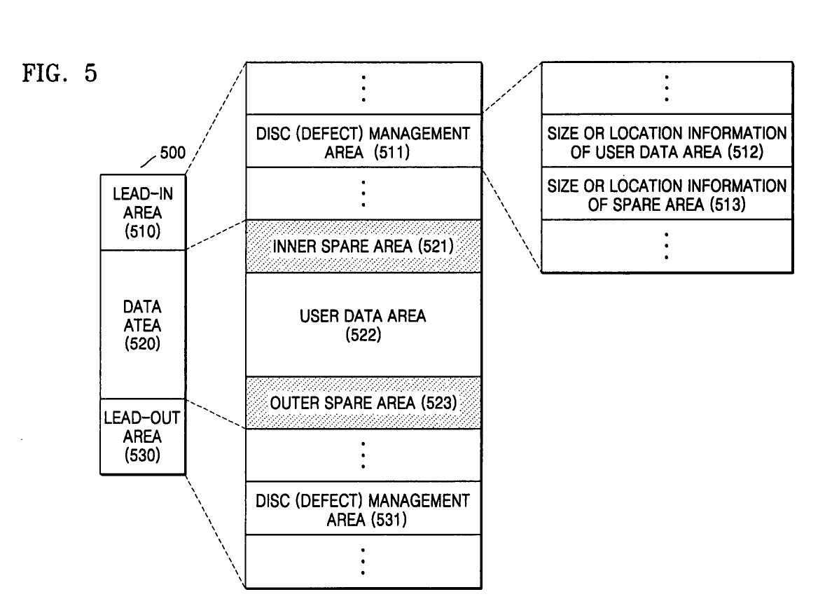

FIG. 5 is a reference diagram illustrating a disc area to which the present invention is applied.

Referring to FIG. 5 a lead-in area 510, a data area 520, and a lead-out area 530 are disposed on the disc 500.

The lead-in area 510 includes a disc management area 511, and the lead-out area 530 includes a disc management area 531. The disc management areas 511 and 531 are also referred to as defect management areas according to the standard of a disc. Information for managing the disc is recorded in the disc management areas 511 and 531. This information for managing a disc includes information regarding the size and/or location of a user data area 512, and information regarding the size and/or location of a spare area 513. The drive system allocates the user data area and the spare area of the disc, and then records information regarding the size and/or location of the allocated user data area and that of the spare area in the disc management area 511 such that after that time when the data recorded on the disc is reproduced, reproduction is performed by referring to the size information of this user data area.

The data area 520 includes an inner spare area 521, a user data area 522, and an outer spare area 523. The user data area 522 is an area in which user data is recorded, and the inner spare area 521 and the outer spare area 523 are areas in which replacement data replacing defect data is recorded when a defect occurs in the user data recorded in the user data area 522. The spare area is allocated when the disc is initialized or re-initialized. An initial file system which is recorded when the disc is initialized is recorded in the start address or end address of the user data area 522.

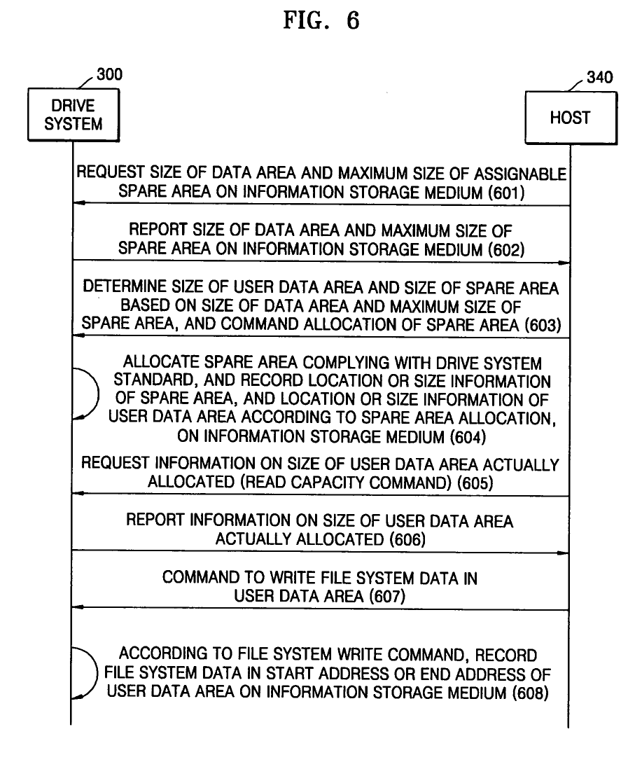

FIG. 6 is a flowchart of a process of formatting a write once recording medium or rewritable medium according to an embodiment of the present invention.

First, a host 340 requests, from a drive system 300, information regarding the size of a data area and the maximum size of a spare area that can be allocated on the information storage medium in operation 601.

The drive system 300 receives the request from the host 340 and reports information regarding the size of a data area, and the maximum size of a spare area that can be allocated on the information storage medium, to the host 340 in operation 602.

The host 340 receives the report and determines the size of the user data area and the size of the spare area to be allocated based on the size of the data area on the information storage medium and the possible size of the spare area that can be allocated by the drive system 300, and commands the drive system 300 to allocate the spare area in operation 603.

The drive system 300 receives a formatting command including the allocation of the spare area from the host 340 and allocates the spare area according to a predetermined rule, and records the location or size information of the spare area, and the location or size information of the user data area according to the allocation of the spare area, in a predetermined area on the information storage medium in operation 604.

Next, before sending a file system write command, the host 340 requests, from the drive system 300, information regarding the size of the user data area actually allocated on the medium by using a read capacity command in operation 605.

The drive system 300 receives the read capacity command from the host 340 and reports the information regarding the size of the user data area actually allocated on the medium to the host 340 in operation 606.

According to this report regarding the content of the drive system 300, the host learns information regarding the user data area actually allocated on the medium, and, based on the information regarding the actually allocated user data area, the host sends a command to the drive system 300 to record a file system data in this user data area in operation 607.

The drive system receives this file system write command from the host 340 and records the file system data in the start address or end address of the user data area on the information storage medium in operation 608. Thus, the file system data is recorded in the start address or end address of the actually allocated user data area such that after that time the host can obtain information regarding the file system from the location in which this file system is actually recorded, without failure, and therefore errors of recording data on or reproducing data from the medium can be reduced.

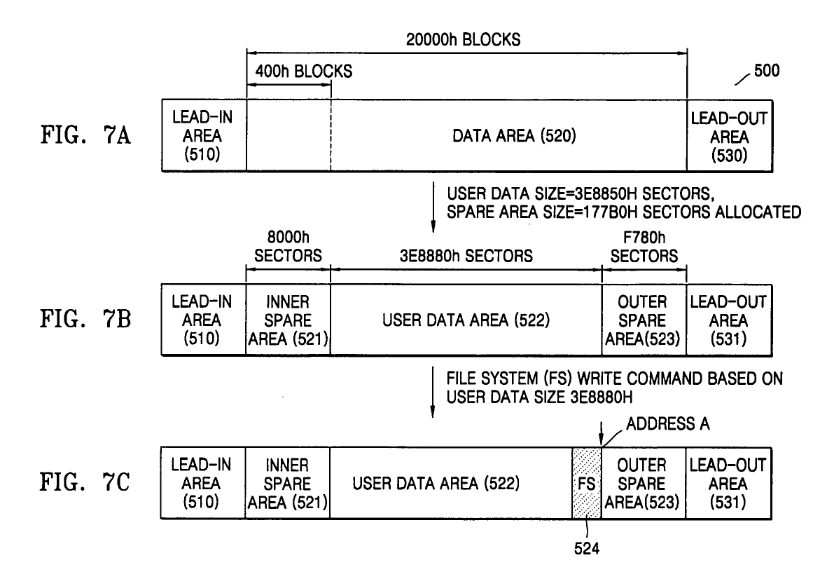

FIGS. 7A-7C are reference diagrams illustrating allocation of a user data area and a spare area on a medium in a formatting process according to an embodiment of the present invention.

FIG. 7 A shows a state of a recording medium which is not formatted, FIG. 7B shows a state of a recording medium on which a spare area is allocated by a command from a host, and FIG. 7 C shows a state of a recording medium on which a file system data is recorded in a user data area according to the command from the host.

Referring to FIG. 7 A, the recording medium, which in this embodiment is a disc, that is not formatted has a lead-in area 510, a data area 520, and a lead-out area 530. It is assumed that size of the data area 520 is 20000h blocks. Assuming that 1 block is 32 sectors (32*2048 bytes), this corresponds to 400000h sectors in hexadecimals. It is assumed that the size of a spare area permitted by the drive system is a minimum of 400h blocks, and a maximum of 1000h blocks, and a standard for the drive system or the disc fixes the size of the “inner spare area” as 400h blocks, and forces the size of the “outer spare area” to be a multiple of a predetermined block size (N=80h).

According to the request of the host, as in operation 601 of FIG. 6, the drive system reports to the host that “the size of the data area=400000h sectors (20000h blocks*20h sectors) and the maximum size of the spare area that can be allocated=20000h sectors (1000h blocks*20h sectors).” The drive system processes the size of data in units of blocks, but the host processes the size of data in units of sectors.

Assuming that 1 block is 32 sectors, and since 32 is 20h in the hexadecimal notation, 1 block is therefore 20h sectors.

It is assumed that, after receiving this report from the drive system, the host commands the drive system to allocate “the size of the user data=3E8850h sectors and the size of the spare area to be allocated=177B0h”. Since the host accesses data in units of sectors, this is a valid command that may be sent by the host.

Then, the user data size 3E8850h sectors are rounded up to 3E8860h to become block data (since the drive system accesses in units of blocks), and the spare area is recalculated as 177A0h. The drive system first allocates 8000h sectors (400h blocks) to the inner spare area 521, and, for the outer spare area 523, performs the calculation again, for the F7A0h sectors (177A0h-8000h) that remain after allocation of the inner spare area 521, with a multiple of a predetermined block size (N=80h). Also, the maximum sectors that can be allocated to the outer spare area 523 are F780h (since it should be a multiple of 80h). Accordingly, the size of the user data area 522 actually allocated on the medium by the drive system is 3E8880h sectors (400000h-17780h). Then, the drive system records the size information (8000h sectors and F780h sectors) of the allocated inner and outer spare areas, and the resulting actual size information (3E8880h sectors) of the user data area, on the recording medium as disc management information.

After this, according to the present invention, the host requests, from the drive system, the size of the user data area actually allocated on the disc. In response to this, the drive system reports “3E8880h sectors”, the information regarding the size of the user data area actually allocated on the disc, such that the host can know the size of the actually allocated user data area. Accordingly, when the host sends a file system write command to the drive system, the host can send the command based on the information regarding the size of the actually allocated user data area. That is, the host sends a file system (FS) write command based on the actual size of the user data area, 3E8880h sectors.

The file system data can be recorded in the start address or end address of the actually allocated user data area. For example, when the file system data is recorded in the end address of the user data area, the file system data can be recorded accurately at the end address of the user data area as shown in FIG. 7 C.

Accordingly, the file system is recorded at the address (address A, the address based on the user data size 3E8880h sectors) according to the intention of the host, and, after that time, when the host reproduces the file system data recorded in the user data area, the drive system reports the actual size information (3E8880h sectors) of the user data area, recorded as disc management information, to the host. Accordingly, the host transmits a command to the drive system to reproduce a file system data at address A (the address based on the actual user data size of 3E8880h sectors) according to the reported information, and the drive system can read the file system data 524 accurately from address A. Accordingly, since errors in the operation to obtain the file system can be reduced, errors in reproducing data recorded on the recording medium and recording data on the recording medium can therefore be reduced. Also, in the above embodiments, the size of the user data area is mainly explained as the example, but since location information can also determine a user data area, any of the size and/or location information can be used.

The formatting method as described above can also be embodied as computer readable codes on a computer readable recording medium. The computer readable recording medium is any data storage device that can store data which can be thereafter be read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments to accomplish the present invention can be easily construed by programmers skilled in the art to which the present invention pertains.

According to the present invention as described above, by recording file system information in a user data area actually allocated when a recording medium is formatted, errors in reproducing data can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A host apparatus to format a recording medium, the host apparatus comprising:
a control unit to request a recording and/or reproducing apparatus which allocates a spare area in a data area on the recording medium to format the recording medium, and to request information regarding a size and/or location of a user data area actually allocated on the recording medium in order to determine the size and/or location of the actually allocated user data area.

2. The apparatus of claim 1, wherein the control unit further transmits a file system write command to the recording and/or reproducing apparatus based on the information regarding the size and/or location of the actually allocated user data area.

3. A recording and/or reproducing apparatus to format a recording medium, the apparatus comprising:
a writing/reading unit to write data on or read data from the recording medium; and
a control unit to control the writing/reading unit, to allocate a spare area in a data area on the recording medium to format the recording medium, and to provide information regarding a size and/or location of a user data area actually allocated on the recording medium to a host apparatus.

4. The apparatus of claim 3, wherein the control unit receives a file system write command based on the information regarding the size and/or location of the actually allocated user data area from the host apparatus, and controls the writing/reading unit to write file system data in the actually allocated user data area of the recording medium.

5. A method of formatting a recording medium, the method comprising:
requesting information, from a recording and/or reproducing apparatus which allocates a spare area in a data area on the recording medium to format the recording medium, regarding a size and/or location of a user data area actually allocated on the recording medium; and
determining the size and/or location of the user data area of the recording medium according to the information regarding the size and/or location of the actually allocated user data area received from the recording and/or reproducing apparatus.

6. The method of claim 5, further comprising:
transmitting a file system write command to the recording and/or reproducing apparatus based on the information regarding the size and/or location of the actually allocated user data area.

7. A method of formatting a recording medium, the method comprising:
allocating a spare area in a data area on the recording medium to format the recording medium; and
providing information regarding a size and/or location of a user data area actually allocated on the recording medium to a host apparatus.

8. The method of claim 7, further comprising:
receiving, from the host apparatus, a file system write command based on the information regarding the size and/or location of the actually allocated user data area; and
recording file system data in the actually allocated user data area of the recording medium.

9. A method of formatting a recording medium, the method comprising:
controlling a recording and/or reproducing apparatus to allocate a spare area in a data area on the recording medium to format the recording medium;
requesting information from the recording and/or reproducing apparatus regarding a size and/or location of a user data area actually allocated on the recording medium;
determining the size and/or location of the actually allocated user data area of the recording medium according to the information regarding the size and/or location of the actually allocated user data area received from the recording and/or reproducing apparatus; and
controlling the recording and/or reproducing apparatus to record file system information based on the determined size and/or location of the actually allocated user data area.

10. A method of formatting a recording medium, the method comprising:
allocating a spare area in a data area on the recording medium to format the recording medium;
receiving a request from a host apparatus for information regarding a size and/or location of a user data area actually allocated on the recording medium;
providing the information regarding the size and/or location of the user data area actually allocated on the recording medium to the host apparatus; and
recording file system information in the actually allocated user data area according to a file system write command transmitted by the host apparatus based on the size and/or location of the actually allocated user data area.

11. A host apparatus to format a recording medium, the host apparatus comprising:
a control unit to receive information regarding a size and/or location of a user data area actually allocated in a data area on the recording medium.

12. The apparatus of claim 11, wherein the control unit further transmits a file system write command to a recording and/or reproducing apparatus based on the information regarding the size and/or location of the actually allocated user data area.

13. The apparatus of claim 12, wherein the control unit controls the recording and/or reproducing apparatus to write file system data in the actually allocated user data area.

14. A recording and/or reproducing apparatus to format a recording medium, the apparatus comprising:
a control unit to receive a request a request for information regarding a size and/or location of a user data area after allocating the user data area in a data area of the recording medium, and to provide the information regarding the size and/or location of the user data area actually allocated.

15. A method of formatting a recording medium, the method comprising:
receiving information regarding a size and/or location of a user data area actually allocated on the recording medium from a recording and/or reproducing apparatus after allocation of the user data area; and
recording file system data in the actually allocated user data area.

16. The method of claim 15, further comprising recording the file system data in a start address or end address of the actually allocated user data area.

17. A method of formatting a recording medium, the method comprising:
allocating a user data area and a spare area in a data area of the recording medium; and
recording information regarding a size and/or location of the allocated user data area and spare area in a disc management area;
wherein reproduction of data on the recording medium is performed according to the recorded size and/or location information.
